(19) United States
(12) Patent Application Publication
(10) Pub. No.: US 2025/0315875 A1
(43) Pub. Date: Oct. 9, 2025

(54) USING A LANGUAGE MODEL FOR SUGGESTING RECIPES BASED ON USER PREFERENCES AND DATA QUERIED FROM A CATALOG DATABASE

(71) Applicant: Maplebear Inc., San Francisco, CA (US)

(72) Inventors: Reece Boyd, Brentwood, TN (US); Mridul Singhai, San Francisco, CA (US); Joseph Olivier, San Bruno, CA (US); Brent Luna, Oakland, CA (US); Lukasz Czekaj, North Las Vegas, NV (US); Nathan Marks, Toronto (CA)

(21) Appl. No.: 18/629,548

(22) Filed: Apr. 8, 2024

(51) Int. Cl. G06Q 30/0601; G06F 16/332; G06F 16/338

(52) U.S. Cl. CPC G06Q 30/0631; G06F 16/3328; G06F 16/3329; G06F 16/338; G06Q 30/0641

(57) ABSTRACT

A language model is used to suggest content based on preferences of a user of an online system and data queried from a catalog database of the online system. The online system gathers input data including a set of recipes and user data and generates a prompt for input into the language model that includes the input data. The online system requests the language model to generate, based on the prompt input into the language model, the list of recipes for the user, wherein each recipe includes a list of ingredients. The online system selects one or more recipes from the list of recipes for presentation to the user. The online system causes a device associated with the user to display a user interface with a suggestion for the user to include, in a cart, a set of ingredients of the selected one or more recipes.

### BACKGROUND

When a user of an online system, such as an online concierge system, is trying to build a cart of items, e.g., for a recipe, it is often difficult to navigate through a user interface of the online system and find each desired item. It is especially hard for new online users to navigate through the user interface of the online system to grab every single item they need for a recipe, i.e., for content composed of multiple items. Thus, it is desirable to improve a user interface of the online system to help an online user find all items for multi-item content (e.g., recipe) in a fast and efficient manner. However, there is a technical problem of how to generate a user interface of the online system with accurate and detailed multi-item content that is specific for a particular user, but also automatic to provide accurate and detailed multi-item content at a large enough scale as required by the online system.

### SUMMARY

Embodiments of the present disclosure are directed to using a model (e.g., language model) of an online system (e.g., online concierge system) for suggesting content (e.g., recipes, items, etc.) based on preferences of a user of the online system and data queried from a catalog database of the online system (e.g., changes of item prices).

In accordance with one or more aspects of the disclosure, the online system monitors a database of the online system for changes in a set of features for a set of items at the database. The online system gathers input data including a set of recipes and user data associated with a user of the online system, wherein items in the set of items include ingredients of the set of recipes. The online system tunes a large language model (LLM) using the gathered input data. The online system generates a prompt for input into the LLM, the prompt including the gathered input data and a request for generating a list of recipes for the user. The online system requests the LLM to generate, based on the prompt input into the LLM, the list of recipes for the user, wherein each recipe in the list of recipes includes a list of ingredients. The online system selects one or more recipes from the list of recipes for presentation to the user. The online system causes a device associated with the user to display a user interface with a suggestion for the user to include, in a cart, a set of ingredients of the selected one or more recipes.

### BRIEF DESCRIPTION OF THE DRAWINGS

FIG. 1A illustrates an example system environment for an online concierge system, in accordance with one or more embodiments.

FIG. 1B illustrates an example system environment for an online concierge system, in accordance with one or more embodiments.

FIG. 2 illustrates an example system architecture for an online concierge system, in accordance with one or more embodiments.

FIG. 3 illustrates an example architectural flow diagram of using one or more language models to suggest content based on preferences of a user of an online concierge system and data queried from a catalog database of the online concierge system, in accordance with one or more embodiments.

FIG. 4 illustrates an example user interface of a device associated with a user of an online concierge system with multi-item content generated by a language model, in accordance with one or more embodiments.

FIG. 5 is a flowchart for a method of using a language model to suggest content based on preferences of a user of an online concierge system and data queried from a catalog database of the online concierge system, in accordance with one or more embodiments.

### DETAILED DESCRIPTION

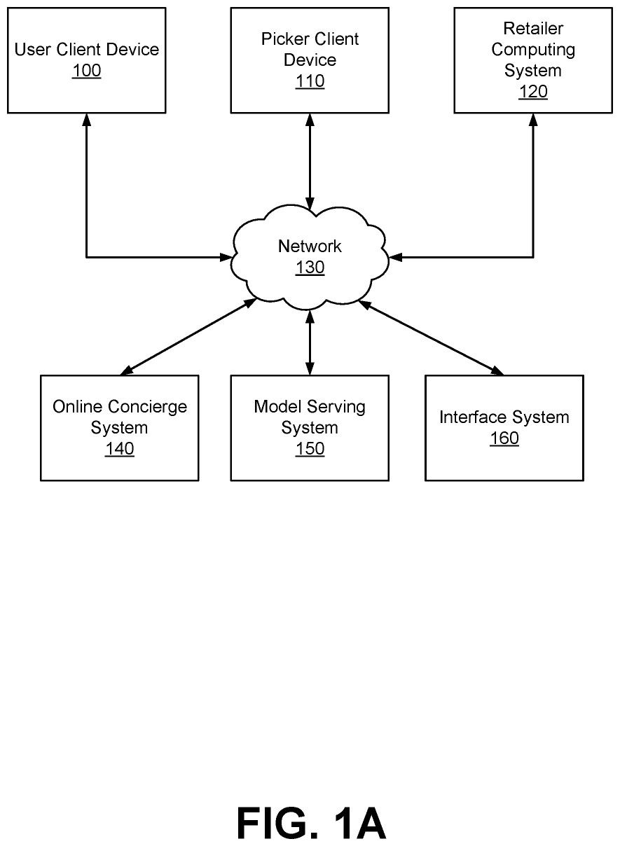

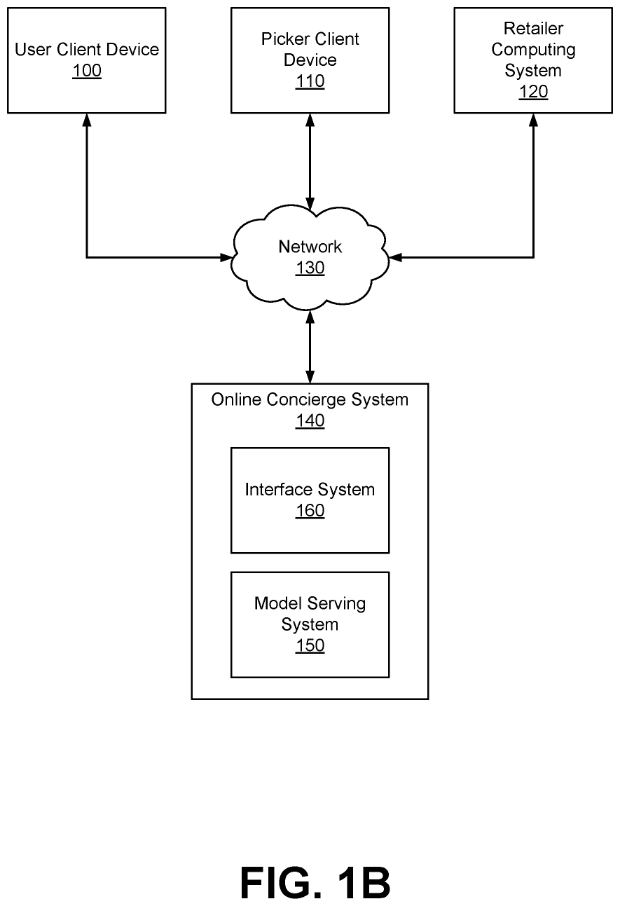

FIG. 1A illustrates an example system environment for an online concierge system 140, in accordance with one or more embodiments. The system environment illustrated in FIG. 1 includes a user client device 100, a picker client device 110, a retailer computing system 120, a network 130, an online concierge system 140, a model serving system, and an interface system 160. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1A, any number of users, pickers, and retailers may interact with the online concierge system 140. As such, there may be more than one user client device 100, picker client device 110, or retailer computing system 120.

The user client device 100 is a client device through which a user may interact with the picker client device 110, the retailer computing system 120, or the online concierge system 140. The user client device 100 can be a personal or mobile computing device, such as a smartphone, a tablet, a laptop computer, or desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item,” as used herein, means a good or product that can be provided to the user through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user, so that the user can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a picker from a retailer. The online concierge system 140 receives orders from the user client device 100 through the network 130. The online concierge system 140 selects a picker to service the user's order and transmits the order to the picker client device 110 associated with the picker. The picker collects the ordered items from a retailer location and delivers the ordered items to the user. The online concierge system 140 may charge a user for the order and provide portions of the payment from the user to the picker and the retailer.

As an example, the online concierge system 140 may allow a user to order groceries from a grocery store retailer. The user's order may specify which groceries they want delivered from the grocery store and the quantities of each of the groceries. The user client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140.

The online concierge system 140 utilizes a user interface of the user client device 100 to suggest content (e.g., recipes and/or items) to a user to enable a user online concierge system 140 placing orders for groceries more easily. To find appropriate recipes and/or items to select to a particular user, the online concierge system 140 fine-tunes a large language model (LLM) with information about the items available for sale and their prices, including any recent price discounts, promotions, or sales, as well as user data such as user's preferences and past orders. The online concierge system 140 then prompts the LLM to generate one or more recipes for the user, focusing on recipes that include items having recent price discounts. Finally, the online concierge system 140 scores and ranks the recipes, and selects one or more recipes to display to the user at the user interface of the user client device 100. The online concierge system 140 may further use a second LLM to determine whether to present the recipe suggestions to the user, based on feedback about previous suggestions and user reactions thereto.

Hence, the online concierge system 140 presented herein utilizes an agentic system that receives catalog items, recipe information and user preferences, and then outputs recipe suggestions and/or item suggestions. The agentic system helps suggest recipes and/or items based on user preferences and price decreases from, e.g., new sales and promotions. The agentic system may be fed by catalog information on a recurring basis, and synthesize content with a particular users' preferences, based on their past orders as well as other metadata. The generated content (e.g., recipe suggestions and, optionally, item suggestions) may be surfaced to the user through a storefront of an application of the online concierge system 140 running on the user client device 100 and optionally through a communication interface (e.g., mailer system) associated with the user.

The model serving system 150 receives requests from the online concierge system 140 to perform tasks using machine-learning models. The tasks include, but are not limited to, natural language processing (NLP) tasks, audio processing tasks, image processing tasks, video processing tasks, and the like. In one or more embodiments, the machine-learning models deployed by the model serving system 150 are language models configured to perform one or more NLP tasks. The NLP tasks include, but are not limited to, text generation, query processing, machine translation, chatbots, and the like. In one or more embodiments, a language model of the model serving system 150 is configured as a transformer neural network architecture (i.e., a transformer model). Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learning model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online concierge system 140 or one or more entities different from the online concierge system 140. An LLM may be trained on a large amount of data from various data sources. For example, the data sources include websites, articles, posts on the web, and the like. From this massive amount of data coupled with the computing power of LLM, the LLM is able to perform various tasks and synthesize and formulate output responses based on information extracted from the training data.

In one or more embodiments, when the machine-learning model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In one or more other embodiments, the transformer architecture may have an encoder-decoder architecture and includes a set of encoders coupled to a set of decoders. An encoder or decoder may include one or more attention operations.

While a LLM with a transformer-based architecture is described in one or more embodiments, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

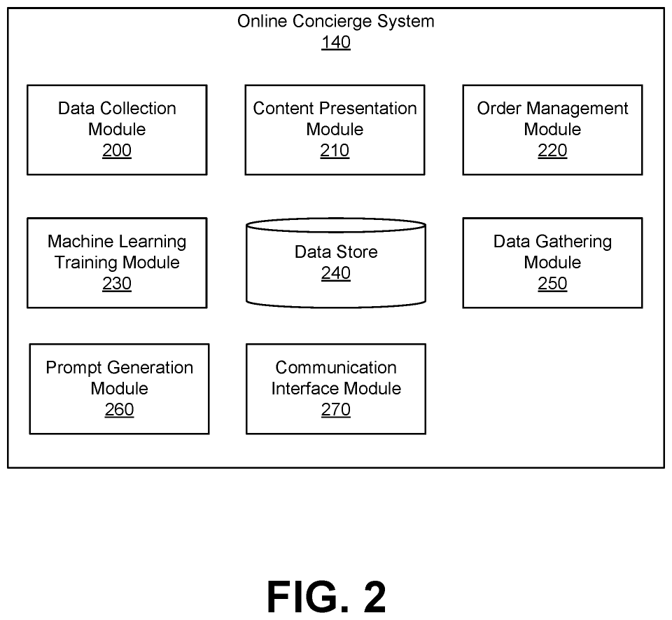

The online concierge system 140 may prepare (e.g., via a data gathering module 250 and a prompt generation module 260 in FIG. 2) a prompt for input to the LLM of the model serving system 150. The prompt may include catalog information (e.g., stored at the data store 240) with details about new sales, ending sales, new items within the catalog, item prices, price discounts, etc. The prompt may further include user information about a user's order history and metadata that inform the LLM what types of food a user may be interested in, how cost-sensitive the user is, and how much the user typically orders for (e.g., are they cooking for themselves, or a large family). The prompt may further include a request for the LLM to generate recipes by focusing on, e.g., discounted items, as well as a request for the LLM to rank the generated recipes based on, e.g., user's preferences and/or likelihood of conversion. An example prompt that includes the aforementioned requests can be: “Generate 10 recipes that are the most discounted. Rank these recipes based on the previously provided user's preferences.”

The online concierge system 140 may receive a response to the prompt from the model serving system 150 based on execution of the machine-learning model using the prompt. The response may include a list of recipes and items created by synthesizing the catalog information and the user's preferences that were input to the LLM as part of the prompt. The online concierge system 140 may import the response from the model serving system 150 and use the response to create a carousel for displaying to the user on, e.g., a storefront page of the application of the online concierge system 140 running on the user client device 100. Alternatively or additionally, the online concierge system 140 may surface the response to the user through a communication interface (e.g., chat) in relation to the user client device 100 or via a user's email.

In one or more embodiments, the task for the model serving system 150 is based on knowledge of the online concierge system 140 that is fed to the machine-learning model of the model serving system 150, rather than relying on general knowledge encoded in the model weights of the model. Thus, one objective may be to perform various types of queries on the external data in order to perform any task that the machine-learning model of the model serving system 150 could perform. For example, the task may be to perform question-answering, text summarization, text generation, and the like based on information contained in an external dataset.

Thus, in one or more embodiments, the online concierge system 140 is connected to an interface system 160. The interface system 160 receives external data from the online concierge system 140 and builds a structured index over the external data using, for example, another machine-learned language model or heuristics. The interface system 160 receives one or more queries from the online concierge system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 150 and synthesizes a response to the query on the external data. While the online concierge system 140 can generate a prompt using the external data as context, often times, the amount of information in the external data exceeds prompt size limitations configured by the machine-learning language model. The interface system 160 can resolve prompt size limitations by generating a structured index of the data and offers data connectors to external data sources.

FIG. 1B illustrates an example system environment for an online concierge system 140, in accordance with one or more embodiments. The system environment illustrated in FIG. 1B includes a user client device 100, a picker client device 110, a retailer computing system 120, a network 130, and an online concierge system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online concierge system 140. In one or more embodiments, as illustrated in the example system environment in FIG. 1B, the model serving system 150 and/or the interface system 160 is managed and deployed by the entity managing the online concierge system 140. The online concierge system 140 is described in further detail below with regards to FIG. 2.

FIG. 2 illustrates an example system architecture for the online concierge system 140, in accordance with some embodiments. The system architecture illustrated in FIG. 2 includes a data collection module 200, a content presentation module 210, an order management module 220, a machine-learning training module 230, a data store 240, a data gathering module 250, a prompt generation module 260, and a communication interface module 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. For example, the data collection module 200 may collect the user data that include a user's name, address, shopping preferences, favorite items, or stored payment instruments. The data collection module 200 may collect the user data that also include default settings established by the user, such as a default retailer/retailer location, payment instrument, delivery location, or delivery timeframe. The data collection module 200 may collect the user data from sensors on the user client device 100 or based on the user's interactions with the online concierge system 140.

The data collection module 200 also collects item data, which is information or data that identifies and describes items that are available at a retailer location. The data collection module 200 may collect the item data that include item identifiers for items that are available and may include quantities of items associated with each item identifier. Additionally, the data collection module 200 may collect the item data that also include attributes of items such as the size, color, weight, stock keeping unit (SKU), or serial number for the item. The data collection module 200 may collect the item data that further include purchasing rules associated with each item, if they exist. For example, age-restricted items such as alcohol and tobacco are flagged accordingly in the item data. The data collection module 200 may collect the item data that also include information that is useful for predicting the availability of items in retailer locations. For example, the data collection module 200 may collect the item data that include, for each item-retailer combination (a particular item at a particular warehouse), a time that the item was last found, a time that the item was last not found (a picker looked for the item but could not find it), the rate at which the item is found, or the popularity of the item. The data collection module 200 may collect the item data from the retailer computing system 120, the picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the data collection module 200 may collect the picker data for a picker that include the picker's name, the picker's location, how often the picker has serviced orders for the online concierge system 140, a user rating for the picker, which retailers the picker has collected items at, or the picker's previous shopping history. Additionally, the data collection module 200 may collect the picker data that include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects the picker data from sensors of the picker client device 110 or from the picker's interactions with the online concierge system 140.

Additionally, the data collection module 200 collects order data, which is information or data that describes characteristics of an order. For example, the data collection module 200 may collect the order data that include item data for items that are included in the order, a delivery location for the order, a user associated with the order, a retailer location from which the user wants the ordered items collected, or a timeframe within which the user wants the order delivered. Also, the data collection module 200 may collect the order data that further include information describing how the order was serviced, such as which picker serviced the order, when the order was delivered, or a rating that the user gave the delivery of the order. In some embodiments, the data collection module 200 collects the order data that include user data for users associated with the order, such as user data for a user who placed the order or picker data for a picker who serviced the order.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from the user client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use the user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may re-train the machine-learning model based on the actual performance of the model after the online concierge system 140 has deployed the model to provide service to users. For example, if the machine-learning model is used to predict a likelihood of an outcome of an event, the online concierge system 140 may log the prediction and an observation of the actual outcome of the event. Alternatively, if the machine-learning model is used to classify an object, the online concierge system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online concierge system 140 as a whole in its performance of the tasks described herein.

The data store 240 stores data used by the online concierge system 140. For example, the data store 240 stores user data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

With respect to the machine-learning models hosted by the model serving system 150, the machine-learning models may already be trained by a separate entity from the entity responsible for the online concierge system 140. In one or more other embodiments, when the model serving system 150 is included in the online concierge system 140, the machine-learning training module 230 may further train parameters of the machine-learning model based on data specific to the online concierge system 140 stored in the data store 240. As an example, the machine-learning training module 230 may obtain a pre-trained transformer language model and further fine tune the parameters of the transformer language model using training data stored in the data store 240. The machine-learning training module 230 may provide the transformer language model to the model serving system 150 for deployment.

The data gathering module 250 may gather data used for tuning of a LLM (e.g., the LLM of the model serving system 150). The data gathering module 250 may gather catalog data with recipe information and/or item information that can be used to feed the LLM on a recurring basis. In particular, the data gathering module 250 may gather the catalog data with information about items whose prices recently changed (e.g., items that are on sale or promotion). In one or more embodiments, the data gathering module 250 gathers the catalog data with a difference in recipe information and/or item information since the last tuning of the LLM. The data gathering module 250 may retrieve the catalog data from one or more catalog of items and recipes stored at the data store 240.

Additionally, the data gathering module 250 may gather user sales data that can be used to feed the LLM. The user sales data may include an order history for the user, a cart size history for the user, historical item quantity information for the user, information about user's purchasing preferences, some other user related data, or some combination thereof. The data gathering module 250 may retrieve the user sales data from the data store 240 or some other module of the online concierge system 140 as the data gathering module 250 can have access to account information of a collection of users of the online concierge system 140. This would allow the data gathering module 250 to collect data such as user's cost-sensitivity, user's item catalog preferences, typical quantities of items that are ordered by the user, etc.

The prompt generation module 260 may generate a prompt for input into the LLM. The prompt may include data gathered by the data gathering module 250, i.e., the catalog data with recipe information and/or item information and the user sales data. The prompt generation module 260 may prompt the LLM to generate one or more recipe suggestions, including a list of ingredients, based on the catalog data and the user sales data. In particular, the prompt generation module 260 may prompt the LLM to focus on recipes that leverage the price decreases, while also aligning with user preferences. The prompt generation module 260 may further include a request into the prompt to ask the LLM to rank the recipe suggestions, e.g., based on the user's preferences.

Based on the prompt input into the LLM, the LLM may generate a response that includes a list of recipes each having a corresponding list of ingredients, a list of items, and metadata in relation to the recipes and items. Based on the prompt, the LLM may infer what types of recipes and items may be compelling for a particular user of the online concierge system 140. The output by the LLM may be imported to the online concierge system 140, e.g., via the content presentation module 210 for displaying at a user interface of the user client device 100. The content presentation module 210 (or some other module of the online concierge system 140) may rank the recipes output by the LLM (e.g., based on a price of each recipe, or some other metric) before displaying one or more recipes with the highest rank at the user interface of the user client device 100. In this manner, a user-specific carousel may be generated that contains recipes and/or items that the LLM believes the user will be interested in, which may be surfaced on a storefront of the user interface. Additionally, the output by the LLM may feed a second LLM (e.g., another LLM of the model serving system 150).

In one or more embodiments, the LLM is given access to one or more application programming interfaces (APIs) of the online concierge system 140. In such cases, the LLM may utilize the one or more APIs to query for a wide range of catalog data and user related data (e.g., stored at various catalogs of the data store 240). The LLM may further use the one or more APIs to publish user-specific carousels of suggested recipes and/or items back to the online concierge system 140 (e.g., via the user interface of the user client device 100). When an LLM interface is integrated with the one or more APIs of the online concierge system 140, the LLM may directly publish user-specific recipes and/or items via the user interface of the user client device 100.

The LLM may be tuned (e.g., via the machine-learning training module 230) using catalog data and user metadata. The user metadata may include information on how often an item is bought by the user after that item is put on sale, information on what are some staple items that are bought by the user, information on how many people does the user tend to shop for, information on whether the user is bias towards on sale items, information on whether the user prefers a certain type of food or recipe during a specific time of the month or year, some other user related information, or some combination thereof.

In one or more embodiments, the online concierge system 140 utilizes a second LLM (e.g., second LLM of the model serving system 150) that is configured as a gatekeeper to decide whether to surface the recipe suggestions via a user interface of the user client device 100. Alternatively, the online concierge system 140 may use a ranking model (e.g., machine-learning model) or ranking system to decide whether to display the suggested recipes at the user interface of the user client device 100. The second LLM may receive information about a user-specific list of recipes and/or items from the first LLM and feed the received information into the user interface of the user client device 100. Alternatively or additionally, the LLM may feed the received information into the communication interface module 270. The communication interface module 270 may provide the information about the user-specific list of recipes and/or items to the user via, e.g., an email or chat of an application associated with the online concierge system 140 running on the user client device 100. This information about the user-specific list of recipes and/or items may surface as links in the email and/or the chart so that the user can conveniently add a set of ingredients of a recipe to their shopping cart.

The model serving system 150 may tune the second LLM using the catalog data and the user sale data gathered by the data gathering module 250. Additionally, the model serving system 150 may tune the second LLM using one or more user related business metrics, such as user's conversion data, information about a user's historical satisfaction in relation to specific items, some other user related metrics, or some combination thereof. The information about user related business metrics may be retrieved from the data store 240 and/or received from the user client device 100 via the network 130.

The prompt generation module 260 may generate a prompt for input into the second LLM. In addition to the list of recipes generated by the first LLM, the prompt for input into the second LLM may include a request for the second LLM to decide whether or not to surface one or more recipes to the user. One example prompt for input into the second LLM can be: “Decide whether or not we should alert this user to this generated list of recipes based on how compelling you think they would be to the user.”

Based on the prompt input into the second LLM, the second LLM may effectively determine if a user of the online concierge system 140 should be alerted to a certain list of user specific recipes and/or items. Based on the prompt, the second LLM may make a determination as to how positively the user will respond to recipe and/or item suggestions. For example, if the second LLM determines that a predetermined threshold metric is exceeded (e.g., threshold likelihood of user's conversion in relation to the recipes and/or items), the second LLM may output the list of recipes and/or items to the content presentation module 210 and/or the communication interface module 270.

The content presentation module 210 may cause the user interface of the user client device 100 to display the list of user-specific recipes and/or items. The list of user-specific recipes and/or items may be directly provided to the content presentation module 210 from the first LLM. Alternatively, the second LLM may approve the list of user-specific recipes and/or items before being provided to the content presentation module 210. The list of user-specific recipes and/or items may be ranked by the first LLM before the list reaches the content presentation module 210. Alternatively, the content presentation module 210 may rank recipes and/or items in the list. The content presentation module 210 may select a predetermined number of highest ranked recipes and/or items from the list for displaying at the user interface of the user client device 100. The selected user-specific recipes and/or items may be displayed in a carousel in, e.g., a storefront page of an application of the online concierge system 140 running on the user client device 100.

Additionally or alternatively, the response from the second LLM with the list of user-specific recipes and/or items may be imported at the online concierge system 140 via one or more out-of-band channels of the communication interface module 270. The communication interface module 270 may select a predetermined number of highest ranked recipes and/or items from the list for surfacing to the user. The communication interface module 270 may surface the selected user-specific recipes and/or items via an email and/or a chat of an application of the online concierge system 140 running on the user client device 100. For example, the chat of the application may pop up with the text: “Check this recipe!”, thus prompting the user to further engage with suggested user-specific ingredients of a recipe as identified by the first LLM. User's engagement data in relation to the email and/or the chat about the user-specific recipes and/or items may be also fed back to the prompt generation module 260 and utilized for generating a new prompt for input into the first LLM so that the first LLM can generate new user-specific content suggestions (e.g., recipes and/or items).

Initially, the second LLM may not be sufficiently accurate. However, the second LLM may be continuously retuned (or, more generally, refined) based on responses from users in relation to the displayed user-specific recipe suggestions and/or item suggestions. For example, if users frequently add suggested recipes to their carts, the second LLM would be positively reinforced. In contrast, if users never add suggested recipes to their carts when the recipes contain one or more specific ingredients, the second LLM would be negatively reinforced.

In one or more embodiments, the first LLM and the second LLM may be retuned (or, more generally, refined) using Reinforcement Learning through Human Feedback (RLHF). Data with information about various user-related metrics (e.g., user satisfaction rates, user re-order rates, user conversions rates, etc.) may be fed back to the first LLM and the second LLM. The types of human feedback may be in the form of how often certain recipes, ingredients, and/or items are added to a user's cart based on the suggestions that the first LLM and the second LLM surface to the user. Additional feedback to the first LLM and the second LLM may include information about retention rates, reorder rates, and/or satisfaction rates of users who are exposed to the outputs of the first LLM and the second LLM. The first LLM and the second LLM may learn that certain recipe ingredients are positively associated with usage and vice versa. In addition, the first LLM and the second LLM may discern important patterns from user metadata that have not previously been considered.

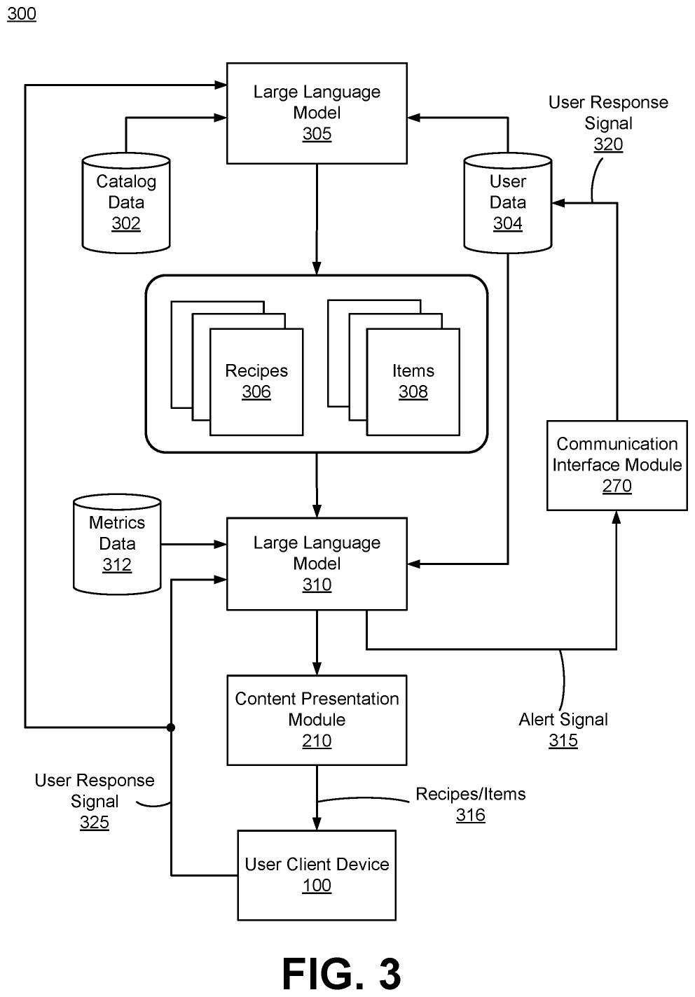

FIG. 3 illustrates an example architectural flow diagram 300 of using language models to suggest content based on preferences of a user of the online concierge system 140 and data queried from a catalog database of the online concierge system 140, in accordance with one or more embodiments. A LLM 305 may be continuously fed by catalog data 302 and user data 304 retrieved from the catalog database (e.g., data store 240) of the online concierge system 140. The LLM 305 may be part of the model serving system 150. The catalog data 302 may include recipe information, information about items having their prices recently decreased (including any information about sales and/or promotions). In one or more embodiments, the catalog data 302 include a difference in a catalog of items and recipes since the last tuning of the LLM 305. The user data 304 may include information about an order history for the user, a cart size history for the user, historical item quantity information for the user, information about user's purchasing preferences, some other user related data, or some combination thereof.

Prompted by the catalog data 302 and the user data 304, the LLM 305 may output a response that includes a set of recipes 306 and a set of items 308 for suggestion to the user. The set of recipes 306 and the set of items 308 output by the LLM 305 may be provided as part of a prompt for an LLM 310 (e.g., second LLM of the model serving system 150). The prompt for input into the LLM 310 may further include metrics data 312 with information about user's conversion data, information about a user's historical satisfaction in relation to specific items (e.g., items in the set of recipes 306 and/or the set of items 308), some other user related metrics, or some combination thereof.

The LLM 310 may act as a gatekeeper, deciding whether to surface the set of recipes 306 and the set of items 308 to the user. When the LLM 310 decides to surface the set of recipes 306 and the set of items 308 to the user, the LLM 310 may output the set of recipes 306 and the set of items 308 to the content presentation module 210. Additionally, the LLM 310 may output an alert signal 315 that is passed to the communication interface module 270. The alert signal 315 may be provided in the form of an email of a chat pop-up message alerting the user about recipe/item suggestions. A response from the user in relation to the alert signal 315 may be recorded as a user response signal 320 and may include information about the user's engagement in relation to the recipe/item suggestions (e.g., conversion of items, viewing of items, viewing of recipes, etc.). The user response signal 320 may be further utilized as part of the user data 304 for feeding the LLM 305. In one or more embodiments, the LLM 310 is bypassed, and the set of recipes 306 and the set of items 308 output by the LLM 305 may be directly passed to the content presentation module 210.

The content presentation module 210 may select a list of recipes and/or items 316 from the set of recipes 306 and the set of items 308 for presentation for the user. When the set of recipes 306 and the set of items 308 were ranked by the LLM 305, the content presentation module 210 may select a predetermined number of recipes with the highest ranks among the set of recipes 306 for presentation to the user. Similarly, the content presentation module 210 may select a predetermined number of items with the highest ranks among the set of items 308 for presentation to the user. Alternatively, when the set of recipes 306 and the set of items 308 were not ranked by the LLM 305, the content presentation module 210 may instead rank the set of recipes 306 and the set of items 308, and then select the list of recipes and/or items 316 based on their ranking scores. The list of recipes and/or items 316 are thus selected as being likely preferred by the user while featuring ingredients/items having recently decreased prices (or being associated with promotions).

The content presentation module 210 may cause the user client device 100 to display a user interface with the list of recipes and/or items 316. The user may utilize the user interface of the user client device 100 to add any of ingredients/items from the list of recipes and/or items 316 to a cart. Alternatively, the user may utilize the user interface of the user client device 100 to only view some recipes and/or items from the list of recipes and/or items 316 without adding them to the cart. Alternatively, the user may choose to ignore the suggested list of recipes and/or items 316. Feedback data with information about engagement by the user in relation to the list of recipes and/or items 316 (e.g., conversion and/or viewing) may be recorded as a user response signal 325. Additionally, the user response signal 325 may include information about a sentiment of the user in relation to the suggested list of recipes and/or items 316 (e.g., as provided via a chat interface of an application of the online concierge system 140 running on the user client device 100). The user response signal 325 may be fed back to the LLM 305 and the LLM 310 and utilized for retuning the LLM 305 and the LLM 310.

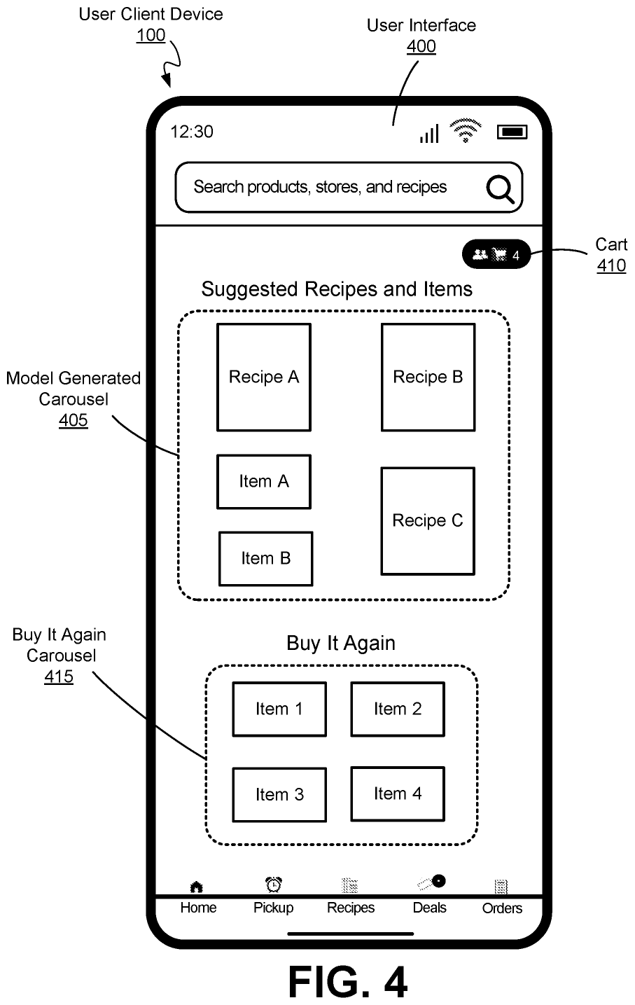

FIG. 4 illustrates an example user interface 400 of the user client device 100 with multi-item content generated by a language model, in accordance with one or more embodiments. The content presentation module 210 may cause the user client device 100 to display the user interface 400 with suggested recipes and items as generated by, e.g., the LLM 305 and allowed for presentation by the LLM 310. The user interface 400 may represent a storefront page of an application of the online concierge system 140 running on the user client device 100. Alternatively, the user interface 400 may be displayed during an ordering session of the user, i.e., before the checkout. The content presentation module 210 may cause the user client device 100 to display a model generated carousel 405 with a list of suggested recipes (e.g., Recipe A, Recipe B, and Recipe C) and a list of suggested items (i.e., Item A and Item B) that were selected for presentation after ranking of recipes and items as performed by the LLM 305 or the content presentation module 210. The user can utilize the user interface 400 to select either all items or a subset of items from any of the suggested Recipes A, B and C for inclusion into a cart 410. Similarly, the user can utilize the user interface 400 to select any of the suggested Items A and B for inclusion into the cart 410. As shown in FIG. 4, the content presentation module 210 may further cause the user interface 400 to display a Buy It Again carousel 415 with a list of items (e.g., Item 1, Item 2, Item 3, Item 4) previously purchased by the user. It should be noted that the list of items displayed in the Buy It Again carousel 415 may not be generated by the LLM 310 and the LLM 315.

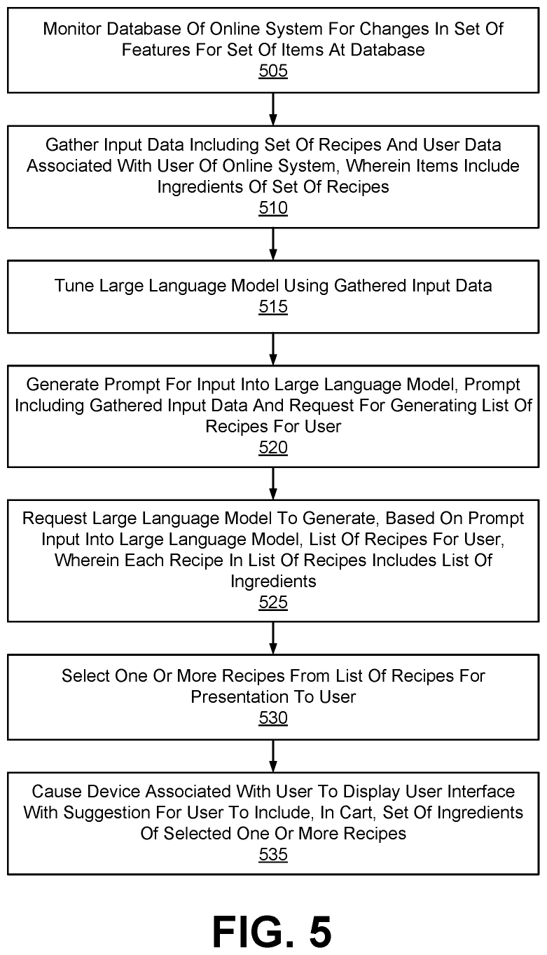

FIG. 5 is a flowchart for a method of using a language model to suggest content based on preferences of a user of an online concierge system and data queried from a catalog database of the online concierge system, in accordance with one or more embodiments. Alternative embodiments may include more, fewer, or different steps from those illustrated in FIG. 5, and the steps may be performed in a different order from that illustrated in FIG. 5. These steps may be performed by an online concierge system (e.g., the online concierge system 140). Additionally, each of these steps may be performed automatically by the online concierge system without human intervention.

The online concierge system 140 monitors 505 (e.g., via the data gathering module 250) a database of the online concierge system 140 (e.g., the data store 240) for changes in a set of features (e.g., prices) for a set of items at the database. The online concierge system 140 gathers 510 (e.g., via the data gathering module 250) input data including a set of recipes and user data associated with a user of the online concierge system 140, wherein items in the set of items include ingredients of the set of recipes. The online concierge system 140 tunes 515 (e.g., via the data gathering module 250 or the prompt generation module 260) a LLM (e.g., LLM of the model serving system 150) using the gathered input data.

The online concierge system 140 may retrieve (e.g., via the data gathering module 250), from the database, the set of recipes associated with the set of items having prices that were decreased within a first time period (e.g., 6 hours, 24 hours, etc.). The online concierge system 140 may further retrieve (e.g., via the data gathering module 250), from the database, the user data including at least one of one or more preferences for the user, an ordering history of the user over a second time period (e.g., month, two months, etc.), an average size of a cart associated with the user, or information about quantity of items ordered by the user over a third time period (e.g., week, two weeks, etc.). In one or more embodiments, the online concierge system 140 accesses (e.g., via the data gathering module 250) an API of the online concierge system 140 to acquire the input data for tuning the LLM.

The online concierge system 140 generates 520 (e.g., via the prompt generation module 260) a prompt for input into the LLM, the prompt including the gathered input data and a request for generating a list of recipes for the user. The online concierge system 140 requests 525 (e.g., via the prompt generation module 260) the LLM to generate, based on the prompt input into the LLM, the list of recipes for the user, wherein each recipe in the list of recipes includes a list of ingredients. The online concierge system 140 selects 530 (e.g., via the content presentation module 210) one or more recipes from the list of recipes for presentation to the user.

The online concierge system 140 may generate the prompt for input into the LLM including (e.g., via the prompt generation module 260) the request into the prompt for generating the list of recipes that are associated with the set of items having prices that were decreased over a defined time period. The online concierge system 140 may request (e.g., via the prompt generation module 260) the LLM to generate, based on the prompt input into the LLM, a score for each recipe in the list of recipes. Alternatively, the online concierge system 140 may score (e.g., via the content presentation module 210), based at least in part on the user data, the list of recipes to generate a score for each recipe in the list of recipes. The online concierge system 140 may identify (e.g., via the content presentation module 210), based on the score for each recipe in the list of recipes, the one or more recipes for presentation to the user.

In one or more embodiments, the online concierge system 140 generates (e.g., via the prompt generation module 260) a second prompt for input into a second LLM (e.g., another LLM of the model serving system 150), the second prompt including the list of recipes, at least a portion of the input data, and feedback data associated with the user. The online concierge system 140 may request (e.g., via the prompt generation module 260) the second LLM to decide, based on the second prompt input into the second LLM, whether to alert the user about the list of recipes. The online concierge system 140 may generate the second prompt for input into the second LLM by obtaining (e.g., via the prompt generation module 260), from at least one of the database or the device associated with the user, the feedback data including at least one of information about conversions by the user in relation to a list of items associated with the list of recipes over a defined time period (e.g., week, two weeks, month, etc.), or information about sentiment of the user in relation to list of items.

Responsive to an alert from the second LLM to the user about the list of recipes, the online concierge system 140 may trigger (e.g., via the content presentation module 210) selection of the one or more recipes from the list of recipes for presentation to the user. Alternatively or additionally, responsive to an alert from the second LLM to the user about the list of recipes, the online concierge system 140 may generate (e.g., via the content presentation module 210) a notification message for the user.

The online concierge system 140 causes 535 (e.g., via the content presentation module 210) a device associated with the user (e.g., the user client device 100) to display a user interface with a suggestion for the user to include, in a cart, a set of ingredients of the selected one or more recipes. Responsive to an alert from the second LLM to the user about the list of recipes, the online concierge system 140 may cause (e.g., via the content presentation module 210) the device associated with the user to display another user interface with the notification message and the selected one or more recipes.

The online concierge system 140 may gather (e.g., via the machine-learning training module 230) tuning data by collecting, from the database, information about at least one of the set of items having prices that were adjusted over a defined time period (e.g., hour, 12 hours, 24 hours, etc.), a set of one or more promotions in relation to the set of items, one or more changes in a catalog of items stored at the database, or information about responses by the user in relation to the set of items. The online concierge system 140 may tune (e.g., via the machine-learning training module 230) the LLM using the gathered tuning data. Furthermore, the online concierge system 140 may collect (e.g., via the machine-learning training module 230) feedback data with information about at least one of a conversion by the user in relation to the set of ingredients of the one or more recipes, or a sentiment of the user in relation to the one or more recipes. The online concierge system 140 may tune (e.g., via the machine-learning training module 230) the LLM using the collected feedback data.

Embodiments of the present disclosure are directed to the online concierge system 140 that uses one or more language models to suggest content based on preferences of a user of the online concierge system 140 and data queried from a catalog database of the online concierge system 140 (e.g., changes of item prices). The online concierge system 140 utilizes the one or more language models prompted with catalog information and user data to suggest recipes for the user. The online concierge system 140 further uses reinforcement learning based on information from user interactions with the suggested recipes, chat interface, etc. to continuously update the one or more language models. The mechanism of the online concierge system 140 presented herein can save time for users who desire easily to find and purchase items that are part of recipes. The presented mechanism can drive growth of the online concierge system 140 and inspire users to add recipes to their carts that they have not previously thought about.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
monitoring a database of an online system for changes in a set of features for a set of items at the database;
gathering input data including a set of recipes and user data associated with a user of the online system, wherein items in the set of items include ingredients of the set of recipes;
tuning a large language model (LLM) using the gathered input data;
generating a prompt for input into the LLM, the prompt including the gathered input data and a request for generating a list of recipes for the user;
requesting the LLM to generate, based on the prompt input into the LLM, the list of recipes for the user, wherein each recipe in the list of recipes includes a list of ingredients;
selecting one or more recipes from the list of recipes for presentation to the user; and
causing a device associated with the user to display a user interface with a suggestion for the user to include, in a cart, a set of ingredients of the selected one or more recipes.

2. The method of claim 1, wherein gathering the input data comprises:
retrieving, from the database, the set of recipes associated with the set of items having prices that were decreased within a first time period; and
retrieving, from the database, the user data including at least one of one or more preferences for the user, an ordering history of the user over a second time period, an average size of a cart associated with the user, or information about quantity of items ordered by the user over a third time period.

3. The method of claim 1, wherein gathering the input data comprises:
accessing an application programming interface (API) of the online system to acquire the input data for tuning the LLM.

4. The method of claim 1, wherein generating the prompt for input into the LLM comprises:
including the request into the prompt for generating the list of recipes that are associated with the set of items having prices that were decreased over a defined time period.

5. The method of claim 1, further comprising:
requesting the LLM to generate, based on the prompt input into the LLM, a score for each recipe in the list of recipes; and
selecting, based on the score for each recipe, the one or more recipes for presentation to the user.

6. The method of claim 1, wherein selecting the one or more recipes comprises:
scoring, based at least in part on the user data, the list of recipes to generate a score for each recipe in the list of recipes; and
identifying, based on the score for each recipe in the list of recipes, the one or more recipes for presentation to the user.

7. The method of claim 1, further comprising:
generating a second prompt for input into a second LLM, the second prompt including the list of recipes, at least a portion of the input data, and feedback data associated with the user; and
requesting the second LLM to decide, based on the second prompt input into the second LLM, whether to alert the user about the list of recipes.

8. The method of claim 7, wherein selecting the one or more recipes for presentation to the user comprises:
responsive to an alert from the second LLM to the user about the list of recipes, triggering selection of the one or more recipes from the list of recipes for presentation to the user.

9. The method of claim 7, further comprising:
responsive to an alert from the second LLM to the user about the list of recipes, generating a notification message for the user; and
causing the device associated with the user to display another user interface with the notification message and the selected one or more recipes.

10. The method of claim 7, wherein generating the second prompt for input into the second LLM comprises:
obtaining, from at least one of the database or the device associated with the user, the feedback data including at least one of information about conversions by the user in relation to a list of items associated with the list of recipes over a defined time period, or information about sentiment of the user in relation to list of items.

11. The method of claim 1, further comprising:
gathering tuning data by collecting, from the database, information about at least one of the set of items having prices that were adjusted over a defined time period, a set of one or more promotions in relation to the set of items, one or more changes in a catalog of items stored at the database, or information about responses by the user in relation to the set of items; and
tuning the LLM using the gathered tuning data.

12. The method of claim 1, further comprising:
collecting feedback data with information about at least one of a conversion by the user in relation to the set of ingredients of the one or more recipes, or a sentiment of the user in relation to the one or more recipes; and
tuning the LLM using the collected feedback data.

13. A computer program product comprising a non-transitory computer readable storage medium having instructions encoded thereon that, when executed by a processor, cause the processor to perform steps comprising:
monitoring a database of an online system for changes in a set of features for a set of items at the database;
gathering input data including a set of recipes and user data associated with a user of the online system, wherein items in the set of items include ingredients of the set of recipes;
tuning a large language model (LLM) using the gathered input data;
generating a prompt for input into the LLM, the prompt including the gathered input data and a request for generating a list of recipes for the user;
requesting the LLM to generate, based on the prompt input into the LLM, the list of recipes for the user, wherein each recipe in the list of recipes includes a list of ingredients;
selecting one or more recipes from the list of recipes for presentation to the user; and
causing a device associated with the user to display a user interface with a suggestion for the user to include, in a cart, a set of ingredients of the selected one or more recipes.

14. The computer program product of claim 13, wherein the instructions further cause the processor to perform steps comprising:
gathering the input data by retrieving, from the database, the set of recipes associated with the set of items having prices that were decreased within a first time period; and
gathering the input data by retrieving, from the database, the user data including at least one of one or more preferences for the user, an ordering history of the user over a second time period, an average size of a cart associated with the user, or information about quantity of items ordered by the user over a third time period.

15. The computer program product of claim 13, wherein the instructions further cause the processor to perform steps comprising:
generating the prompt for input into the LLM by including the request into the prompt for generating the list of recipes that are associated with the set of items having prices that were decreased over a defined time period.

16. The computer program product of claim 13, wherein the instructions further cause the processor to perform steps comprising:
generating a second prompt for input into a second LLM, the second prompt including the list of recipes, at least a portion of the input data, and feedback data associated with the user; and
requesting the second LLM to decide, based on the second prompt input into the second LLM, whether to alert the user about the list of recipes.

17. The computer program product of claim 16, wherein the instructions further cause the processor to perform steps comprising:
responsive to an alert from the second LLM to the user about the list of recipes, triggering selection of the one or more recipes from the list of recipes for presentation to the user.

18. The computer program product of claim 16, wherein the instructions further cause the processor to perform steps comprising:
generating the second prompt for input into the second LLM by obtaining, from at least one of the database or the device associated with the user, the feedback data including at least one of information about conversions by the user in relation to a list of items associated with the list of recipes over a defined time period, or information about sentiment of the user in relation to list of items.

19. The computer program product of claim 13, wherein the instructions further cause the processor to perform steps comprising:
gathering tuning data by collecting, from the database, information about at least one of the set of items having prices that were adjusted over a defined time period, a set of one or more promotions in relation to the set of items, one or more changes in a catalog of items stored at the database, or information about responses by the user in relation to the set of items;
collecting feedback data with information about at least one of a conversion by the user in relation to the set of ingredients of the one or more recipes, or a sentiment of the user in relation to the one or more recipes; and
tuning the LLM using at least one of the gathered tuning data or the collected feedback data.

20. A computer system comprising:
a processor; and
a non-transitory computer-readable storage medium having instructions that, when executed by the processor, cause the computer system to perform steps comprising:
monitoring a database of an online system for changes in a set of features for a set of items at the database;
gathering input data including a set of recipes and user data associated with a user of the online system, wherein items in the set of items include ingredients of the set of recipes;
tuning a large language model (LLM) using the gathered input data;
generating a prompt for input into the LLM, the prompt including the gathered input data and a request for generating a list of recipes for the user;
requesting the LLM to generate, based on the prompt input into the LLM, the list of recipes for the user, wherein each recipe in the list of recipes includes a list of ingredients;
selecting one or more recipes from the list of recipes for presentation to the user; and
causing a device associated with the user to display a user interface with a suggestion for the user to include, in a cart, a set of ingredients of the selected one or more recipes.
